(19) United States
(12) Patent Application Publication
(10) Pub. No.: US 2008/0000461 A1
(43) Pub. Date: Jan. 3, 2008

(54) Structure for Connecting Heat Exchangers

(76) Inventor: Toshimichi Kobayashi, Tokyo (JP)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/579,211

(22) PCT Filed: Nov. 19, 2004
(86) PCT No.: PCT/JP04/17250

§ 371 Date: Oct. 30, 2006

(30) Foreign Application Priority Data
Apr. 30, 2004 (JP) 2004-135225

(51) Int. Cl. F02M 25/07

(52) U.S. Cl. 123/568.12

(57) ABSTRACT

The present invention is a connection structure for connecting heat exchangers (11, 12) to each other that exchange heat between a cooling fluid flowing in body parts (13, 14) and a cooled fluid flowing in heat transfer pipes (15, 16) disposed in the body parts (13, 14). The connection structure comprising connection holes (17, 18) drilled in the body parts (13, 14) of the heat exchangers (11, 12) and connected to each other; and a press-formable connection member 19, connected to the outer surfaces of the body parts (13, 14) around the connecting holes (17, 18) so that the body parts (13, 14) are allowed to communicate with each other.

### FIELD OF THE INVENTION

The present invention relates to a structure for connecting heat exchangers to exchange heat between cooling fluid passing through inside of body parts and fluid to be cooled passing through inside of heat transfer pipes installed in the body parts, such as an EGR (Exhaust Gas Recirculation) cooler and the like to be installed in a vehicle with a diesel engine.

### BACKGROUND OF THE INVENTION

Recently, the case to install the EGR (Exhaust Gas Recirculation) cooler in the vehicle is increasing in order to cut down NOx containing in exhaust gas from a diesel engine since social request related to improvement of the natural environment is increasing. Furthermore, the necessity to install plural connected EGR coolers in one vehicle is also increasing in connection with request to make performance of the EGR cooler high.

The FIG. 4 shows a prior art of the structure for connecting heat exchangers. At the structure for connecting heat exchangers, two EGR coolers 1, 2 are connected in series by welding each end of a U-bend pipe 5 respectively to each body part 3, 4 which cooling fluid passes through because of space problem in the engine room of the vehicle.

After the cooling water which entered into the first EGR 1 cooler through an inlet pipe enters into the second EGR cooler 2 through the U-bend pipe 5, it comes out of a outlet pipe 7. In the meantime, the cooling water exchanges heat between the exhaust gases passing through heat transfer pipes (not shown) installed in each body part 3, 4 and cool down the exhaust gasses.

In addition, at the saltwater heat exchanges used in the nuclear power plant and the like, heat exchanges are connected by the U-bend pipe as the above case (See Japanese Unexamined Utility Model Application No. 56-89590).

However, at the above-mentioned prior structure for connecting heat exchangers, there are problems that it is difficult to form the U-bend pipe and to weld it to the each body part, and that costs for parts and working are expensive, because it is necessary to use the U-bend pipes which bend radius is small to connect the heat exchanges.

Furthermore, there is a problem that it is difficult to install the U-bend pipe in the small space such as the engine room of the vehicle because quite a little space is needed to install the U-bend pipe.

In addition, there is a problem that it is difficult to improve the efficiency because fluid resistance and power for transferring the fluid become larger.

In order to overcome the above problems, the object of the present invention is to provide a structure for connecting heat exchangers to be able to reduce the cost and space for installation and to improve the efficiency.

### SUMMARY OF THE INVENTION

In order to achieve the above objects, the present invention is a structure for connecting heat exchangers to exchange heat between cooling fluid passing through inside of body parts and fluid to be cooled passing through inside of heat transfer pipes installed in the body parts comprising: a connecting hole opened respectively at the each body part of the heat exchangers to be connected; and a connecting member to be able to form by press and to be connected on the external face of the each body part around the connecting hole so that the each body part can go through.

According to the present invention, it is possible to make the working easy, to reduce the cost, and to reduce the space for installation, because the connecting member can be formed by press.

Furthermore, it is possible to design the shape of the connecting member and the connecting hole freely to some extent because the connecting member is connected to the external face of the each body part around the connecting hole without being connected to the connecting hole directly. Accordingly, it is possible to carry out optimum design taking account of the flow and resistance of the cooling water and improve the heat exchange efficiency and reduce the power for transferring the fluid.

### BRIEF DESCRIPTION OF THE DRAWINGS

FIG. 1 is a section view shown a structure for connecting heat exchanges according to an embodiment of the present invention;

FIG. 2 is a perspective view shown the structure for connecting heat exchanges according to the embodiment of the present invention;

FIG. 3 is a perspective view shown another example of the connecting member at the structure for connecting heat exchanges according to the embodiment of the present invention;

FIG. 4 is a section view shown the prior art.

### DESCRIPTION OF THE PREFERRED EMBODIMENT

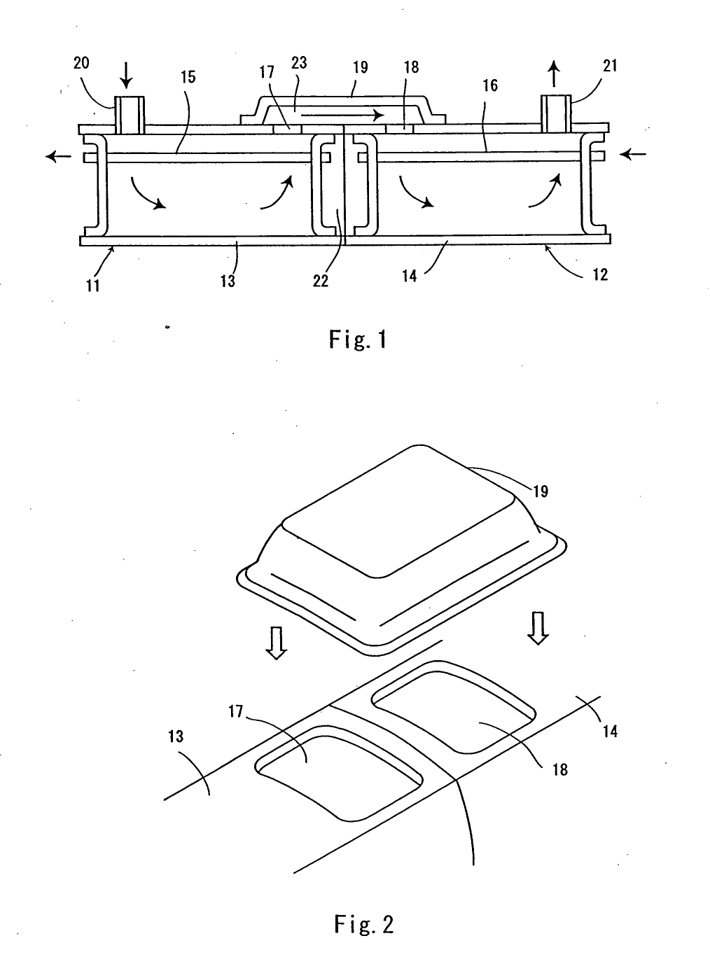

We will now describe an embodiment of the present invention with reference to the accompanying drawings. The FIG. 1 is a section view shown a structure for connecting heat exchanges according to an embodiment of the present invention, and the FIG. 2 is a perspective view shown the structure for connecting heat exchanges according to the embodiment of the present invention. We will describe the case to apply the present invention to the EGR cooler as an example thereinafter.

At the embodiment of the present invention, the first EGR cooler and the second EGR cooler are configured to be connected each other in series. The each EGR cooler 11, 12 essentially consists of a body part 13, 14 and heat transfer pipes 15, 16 installed in the each body part 13, 14 respectively so that heat can exchange between cooling water passing through inside of body parts 13, 14 and exhaust gasses passing through inside of heat transfer pipes 15, 16. A connecting hole 17, 18 is opened respectively at each end adjacent to the connecting part of the first EGR cooler 11 and the second EGR cooler 12 so that a connecting member 19 can be connected the external face of the each body part 13, 14 around the each connecting hole 17, 18 by brazing or welding.

The connecting member 19 is formed in flat plate shape by pressing a plate member. A path 23 is formed between the connecting member 19 and the each body part 13, 14 by connecting the connecting member 19 to the external face of the each body part 13, 14 so that the each body part 13, 14 can go through via the path 23 and the each connecting hole 17, 18. A cooling water inlet pipe 20 is connected to the opposite end of the end which the connecting hole 17 of the first EGR cooler 11 is opened and also a cooling water outlet pipe 21 is connected to the opposite end of the end which the connecting hole 18 of the second EGR cooler 12 is opened. Furthermore, a header part 22 of the heat transfer pipe is formed at the connecting part between the first EGR cooler 11 and the second EGR cooler 12 so that the both heat transfer pipes 15, 16 can go thorough via the header part 22 of the heat transfer pipe.

As the above, it is possible to make the working simple and to reduce the cost since the connecting member 19 can be formed by press. Furthermore, it is possible to design the shape of the connecting hole 17, 18 freely to some extent such as square, oval and the like regardless of the shape of the connecting member 19 and carry out optimum design taking account of the flow and resistance of the cooling water, because the connecting member 19 is not connected to the connecting hole 17, 18 directly. In addition, it is possible to install more than two connecting members 19 since the connecting member 19 is formed in flat plate shape and large space for the installation is not required. Accordingly, in that case, it is possible to make the flow of the cooling water smooth further, improve the heat exchange efficiency and reduce the power for transferring the fluid.

Under the above structure, the cooling water enters into the body part 13 of the first EGR cooler 11 via the cooling water inlet pipe 20, and passes through the connecting hole 17, the path 23, the connecting hole 18. Then the cooling water comes out of the cooling water outlet pipe 21 after passing through the body part 14 of the second EGR cooler 12. On the other hand, a part of the exhaust gasses of the diesel engine pass through the heat transfer pipe 16 of the second EGR cooler 12 to the opposed direction of the flow of the cooling water. Then the exhaust gasses pass return to the an intake part of the diesel engine after passing through the first EGR cooler 11 via the header part 22 of the heat transfer pipe. In the meantime, the cooling water exchanges heat between the exhaust gases and it is cooled down at the preferred condition.

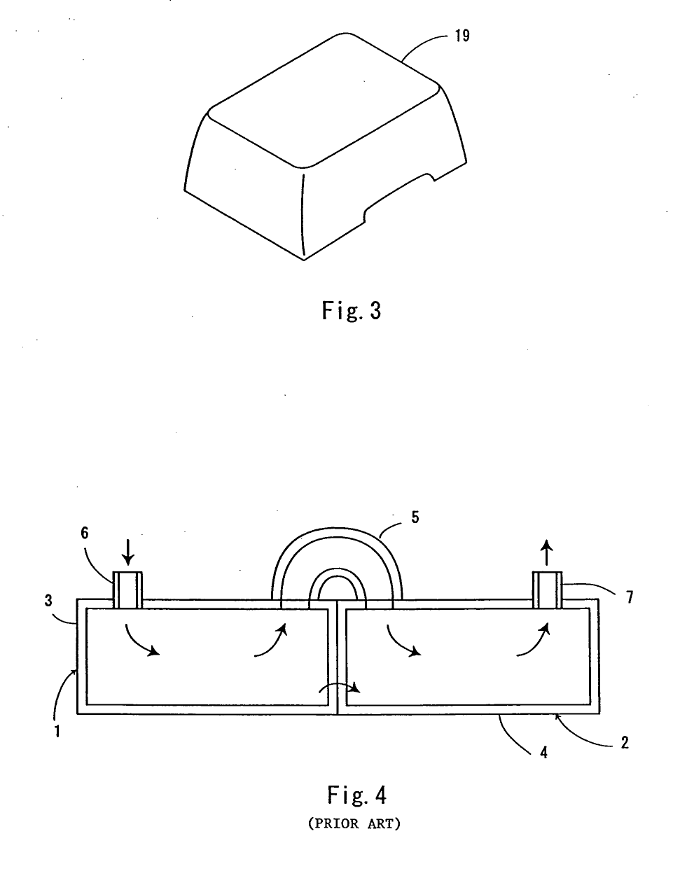

In addition, the connecting member 19 is not limited to the above shape and may be in the other shape which can be pressed, such as vaulting horse shape and the like as shown on the FIG. 3.

Furthermore, although the first EGR cooler 11 and the second EGR cooler 12 are connected in series, the present invention is applicable to the case that the each EGR cooler 11, 12 are connected in parallel, or the case that more than three EGR coolers are connected.

Although the embodiment of the present invention has been described in the EGR cooler, it is to be understood by those skilled in the art that the present invention is applicable to the heat exchangers other than the EGR cooler.

What is claimed is:

1. Structure for connecting heat exchangers to exchange heat between cooling fluid passing through inside of body parts and fluid to be cooled passing through inside of heat transfer pipes installed in the body parts comprising:
a connecting hole opened respectively at the each body part of the heat exchangers to be connected; and
a connecting member to be able to form by press and to be connected on the external face of the each body part around the connecting hole so that the each body part can go through.

2. A structure for connecting heat exchangers to each other that exchange heat between a cooling fluid flowing in body parts and a cooled fluid flowing in heat transfer pipes disposed in the body parts comprising:
connection holes drilled in the body parts of the heat exchangers and connected to each other; and
a press-formable connection member connected to the outer surfaces of the body parts around the connection holes so that the body parts are allowed to communicate with each other.
